(19) United States
(12) Patent Application Publication
(10) Pub. No.: US 2022/0097688 A1
(43) Pub. Date: Mar. 31, 2022

(54) METHOD FOR EVALUATING A METHOD FOR CONTROLLING AN AT LEAST SEMI-AUTOMATED MOBILE PLATFORM

(71) Applicant: Robert Bosch GmbH, Stuttgart (DE)

(72) Inventors: Michael Hanselmann, Korntal-Muenchingen (DE); Dora Ahbe, Stuttgart (DE); Marina Ullmann, Gerlingen (DE)

(21) Appl. No.: 17/448,391

(22) Filed: Sep. 22, 2021

(30) Foreign Application Priority Data
Sep. 30, 2020 (DE) 10 2020 212 347.0

(51) Int. Cl. B60W 30/085; G06N 20/00; B60W 50/14; B60W 30/095; G05D 1/02

(52) U.S. Cl. CPC B60W 30/085; G06N 20/00; B60W 2050/0043; B60W 30/095; G05D 1/0212; B60W 50/14

(57) ABSTRACT

A method for evaluating a first method for a control of an at least semi-automated mobile platform in surroundings of the mobile platform. The method includes: determining a control action using the first method for a setting of the surroundings;

determining a confidence value for the determination of the control action using the first method; determining a representation of the setting of the surroundings of the mobile platform, if the determined confidence value is lower than a trust level, in order to evaluate the first method using this setting.

### BACKGROUND INFORMATION

The automation of driving is accompanied by the equipping of vehicles with increasingly larger-scale and more powerful sensor systems for surroundings detection. Sensor data are consolidated to form a surroundings model for representing surroundings of the vehicle. Requirements related to a scope and to a quality of the surroundings model are, in turn, a function of the driving functions implemented thereon. In the driverless vehicle, entire driving decisions, for example, are made on the basis of the surroundings model and the actuators are activated accordingly.

The open context nature of the surroundings conditions in road traffic represent a major challenge for the development of assistance systems and for the development of (semi-)automated driving functions. In the development of a system for representing the surroundings, it is often not fully predictable which combinations of road topology, traffic flow, weather, lighting, etc. in reality occur and which of these combinations is particularly challenging for an algorithm, for example, for recognizing traffic signs or for behavior planning. This is true of both classical model-based as well as data-based methods.

By introducing expert knowledge or a suitable selection of training data, the attempt is made to interpret the representation of the surroundings in such a way that objects of the surroundings relevant in surroundings to be expected are sufficiently accurately reproduced, or whether it is possible to sufficiently accurately derive a behavior planning therefrom.

However, situations or settings of the surroundings relevant for a practical operation may possibly not have been considered during training or in the interpretation, or training data suitable for certain situations or settings of the surroundings are lacking.

### SUMMARY

According to aspects of the present invention, a method for evaluating a first method for controlling an at least semi-automated mobile platform, a method for providing a control signal, an evaluation device, a computer program and a machine-readable memory medium, are provided. Advantageous embodiments of the present invention are disclosed herein.

In this entire description of the present invention, the sequence of method steps is presented in such a way that the method is easily reproducible. Those skilled in the art will recognize, however, that many of the method steps may also be run through in a different order and lead to the same or to a corresponding result, in view of the disclosure herein. In this sense, the order of the method steps may be changed accordingly. Several features are provided with numerals in order to improve the readability or to make the assignment clearer, however, this does not imply a presence of particular features.

According to one aspect of the present invention, a method is provided for evaluating a first method for controlling an at least semi-automated mobile platform in the surroundings of the mobile platform, which includes the following steps:

In one step, a control action using the first method is determined for a setting of the surroundings. In a further step, a confidence value for the determination of the control action is determined using the first method. In a further step, a representation of the setting of the surroundings of the mobile platform is determined, if the particular confidence value is lower than a trust level, in order to evaluate the first method using this setting.

A mobile platform may be understood to mean an at least partially automated system, which is mobile, and/or a driver assistance system. One example may be an at least semi-automated vehicle or a vehicle that includes a driver assistance system. This means, in this context, an at least partially automated system includes a mobile platform with respect to an at least partially automated functionality, but a mobile platform also includes vehicles and other mobile machines including driver assistance systems.

The term evaluating the first method is to be broadly interpreted and includes an assessment, an analysis and an improvement of the first method.

A setting of surroundings of the mobile platform and its representation includes, in particular, objects and their mutual position and/or orientation or their speed, which are relevant, in particular, for the evaluation of the first method. For example, vehicles at a great distance from an ego vehicle in which the first method is used in test mode, would be of little relevance for a control action such as, for example, a lane change. The setting in this case also includes a position specification such as, for example, a GPS position. For example, it may be checked via the position specification whether control actions with settings in certain infrastructural surroundings such as, for example, expressways and/or tunnels and/or intersections, are determined by the first method with sufficiently high confidence values.

Additionally or alternatively, a map including pieces of lane information and/or traffic signs may be provided for the method in digitized form and/or such a digital map may be generated by the method. The method may then further provide that a position of the mobile platform and/or a respective position of relevant objects is/are assigned to geographical locations of the digital map.

The method may be advantageously used for evaluating in order to enable the method for practical use.

If the first method for controlling relates, in particular, to a method for behavior planning, the first method may be evaluated using this method. In methods for behavior planning, there is namely the problem that in a comparison with, for example, established behavior planning methods, differences with respect to an instantaneous situation may be easily determined. Thus, for example, the first method, as opposed to an established method for behavior planning, may suggest a lane change to the left instead of driving straight-ahead. Since a suggested action of a first method may have an impact in the future, this instantaneously determined difference is insufficient for evaluating the first method, since such an instantaneous difference allows for no conclusion about a further development of the situation in the future.

For example, it is not possible to decide how the situation would have developed in the case of a lane change, i.e., whether, for example, it would be advantageous or even causal to an accident.

The method described herein advantageously allows for an assessment of the first method, in particular, if it is carried out with a multitude of vehicles. If, in particular, the first method is operated in a test mode or in a shadow mode during a use of the mobile platform, the development of the first method may thereby be accelerated and an argument for enabling may also be supported.

With this method, first methods for control or functions may, in particular, be evaluated, whose result or actions may have an impact in the future.

In accordance with an example embodiment of the present invention, in this method, the first method, in particular, may be operated in a test mode or shadow mode in order to collect pieces of information revealing in which settings of a representation of surroundings or in which situations the first method, such as a behavior planner, determines with low confidence actions such as, for example, a control action in order, for example, to improve the first method for such a setting.

In this case, a test mode or shadow mode may be a first method operated in a passive mode, to which input data or further processed input data are provided by sensor systems of the mobile platform, the method in the test mode or shadow mode not being used for controlling or for activating an actuator system of the mobile platform.

For example, an improvement may be achieved in that in first methods, which draw on a data-based function, such settings are incorporated into the data structure of the function in which the control action has been determined with a low confidence value.

If, for example, such a data-based function of the first method has never been trained with dense traffic, but in reality, however is confronted with a setting of a traffic jam, this explains a low confidence value for the determination of a control action. These settings may be identified using the described method for evaluating, in order to evaluate or, if necessary, to improve the corresponding first method. For this purpose, the corresponding setting, in particular, may be abstracted from a multitude of such settings and may be taken into consideration with respect to a refinement of the first method, for example, during training of the behavior policy.

In other words, it is possible using such a method to evaluate a first method for determining a control action by determining with a method for determining a confidence value, the respective confidence values of the control action and collecting representations of settings in a test mode, in which the control action has been determined with a confidence value, which is lower than a trust level. For example, the confidence value may be determined in that the method for determining the confidence value is able to recognize whether it or the present input data, i.e., the representation of the surroundings, is located in an extrapolation area, i.e., no sufficiently similar settings or situations are known from the training or from the manual specification phase, or is located in the interpolation area, which means that sufficiently similar settings or situations are known from the development phase.

A plurality of such settings may be selected on the individual mobile platform, for example, on the basis of this confidence estimation, in order to minimize the number of transferred representations of the settings and associated control actions or confidence values, and are transferred in a wireless and/or hardwired manner and/or connected to a data medium to a center for evaluation, such as a cloud, in order to evaluate them.

For this purpose, the first method, which is based on expert knowledge and/or is implemented with training data in a data-based manner, may be introduced in a training mode or shadow mode operation into a vehicle or into a fleet. In accordance with the desired evaluation, filter criteria for the transfer of the settings may be defined which, for example, describe settings or situations for which there is no sufficiently adequate equivalent in the training data. For example, the settings may be determined in the form of position data (GPS positions) and/or driven trajectories of an ego vehicle and surrounding traffic. Settings filtered in this manner together with other parameters such as, for example, the corresponding confidence value and/or the control action, may be transferred to the center for evaluation (cloud).

The representations of settings collected in this manner may, for example, be utilized in order with respect to classical methods, which are based on expert knowledge, to define explicit rules as to how in such—previously unknown situations—one is to proceed. Alternatively or in addition, the corresponding representations of the settings may be replicated in simulations and/or may be provided for a training of a data-based method. An improved version of the first method may then again be rolled out for further evaluation in a training mode via the fleet of vehicles, in order, with sufficient reliability, to provide an important argument for enabling the first method and/or to run through the method once again in the event of an insufficiently positive result of the evaluation.

Alternatively or in addition, the first method may also be analyzed offline without operation in a test mode. For this purpose, a large volume of data of different settings in different possible surroundings for the mobile platform may be collected and stored. In this case, it is important to adequately consider the settings or situations occurring in reality. When using the first method in a test mode or shadow mode, it is advantageously possible with the aid of filters of the settings to be transferred to make an informed decision as to which settings or situations are of particular relevance, so that only a subset is required to be transferred.

With the method for evaluating a first method for controlling presented herein in accordance with an example embodiment of the present invention, it is thus possible in a test mode or shadow mode to identify unknown driving situations in the form of settings in order to evaluate, in particular, for a first method for the behavior planning.

According to one aspect of the present invention, it is provided that the first method for control of the at least semi-automated platform is a method for the behavior planning of the at least semi-automated mobile platform.

The method provided herein in accordance with an example embodiment of the present invention may be advantageously used for evaluating, in particular, for a first method that relates to a behavior planning, since behavior planning involves actions that have an impact in the future and are able to be only insufficiently characterized for an evaluation by instantaneous comparison with other methods.

A behavior planner may be understood in this case to be a method, which relates to a preliminary stage of a trajectory planning in which, in accordance with a traffic situation/setting in the surroundings of the mobile platform, a decision about a future behavior of the mobile platform is made such as, for example, a decision to carry out a lane change. Alternatively or in addition, a behavior planner may be understood, in particular, to mean a method that provides a trajectory. For this purpose, the behavior planner obtains essential objects, which are determined with the aid of sensor systems, of the surroundings of the mobile platform and their relative arrangement and/or orientation to one another and to the mobile platform in the form of a representation of a setting of the surroundings of the mobile platform with the aid of a surroundings-related parameter as an input variable.

A surroundings-related parameter of a sensor system is a parameter that relates to surroundings of the sensor system and is determined with the aid of a sensor system or of multiple sensor systems. In this case, a surroundings-related parameter may be a parameter, which evaluates and/or aggregates with the aid of data of a sensor system with respect to a measuring goal for representing surroundings of the sensor system.

For example, a segmentation of an image or a stixel or an L-shape of a LIDAR system is evaluated with respect to the measuring goal object detection in order, for example, to recognize, to measure, and to determine the position of an object class auto.

The surroundings-related parameter in this case may be abstracted higher than the pure data of the sensor system. For example, the surroundings-related parameter may include objects, features, stixels, dimensions of respective certain objects, types of objects, three-dimensional “bounding boxes,” classes of objects, L-shapes and/or edges and/or reflection points of, for example, LIDAR systems.

A surroundings-related parameter in this case may also include the data of a sensor system and/or object lists of objects of the surroundings of the mobile platform.

According to one aspect of the present invention, it is provided that the first method is evaluated using a multitude of at least semi-automated mobile platforms and/or the representation of the respective setting of a portion of the multitude of the at least semi-automated mobile platforms is transferred wirelessly to a center for evaluating the first method.

Because this method is applied using a multitude of at least semi-automated mobile platforms, the method is rolled out to a fleet, so that much knowledge about the first method may be advantageously acquired in the field in a relatively short period of time. Thus, on the basis of such an evaluation, a sound enabling decision may be made or a targeted refinement of the first method may be enabled.

According to one aspect of the present invention, it is provided that only a part of the representation of the respective setting is transferred to the center for evaluation and this part is dependent upon the representation of the respective setting and/or of the first method in order to minimize the volume of data to be transferred.

Because only a part of the representations of the respective settings are transferred to the center, at the mobile platform at which the setting-related data are present, it may be advantageously decided which descriptions of situations or representations of settings are transferred to the center for evaluation. In this case, the representations of the settings to be transferred corresponding to the settings relevant for the evaluation of the first method for control may be selected before they are transferred.

According to one aspect of the present invention, it is provided that the respective control action is transferred to the respective at least semi-automated mobile platform. By the transfer of the respective control action, which has been determined in specific settings of the surroundings of the mobile platform, it is advantageously possible to evaluate the first method for control using a multitude of control actions. Alternatively or in addition, a control action of a vehicle driver may then also be transferred when the first method and/or the second method is not active.

According to one aspect of the present invention, it is provided that the first method is operated in a test mode in the respective at least semi-automated mobile platform. In this way, a first method may be evaluated using practical situations even in an earlier development state of the first method. For example, this results in the possibility of comparing the performance of the new first method with the performance of an instantaneous method and/or of a driver of the mobile platform. The collected data such as, in particular, the representations of the settings are then determined and stored and/or transferred to a cloud or to a center for evaluation.

According to one aspect of the present invention, it is provided that the control action is determined using a second method and the second method at least partially controls the at least semi-automated mobile platform for evaluating the first method.

According to one aspect of the present invention, it is provided that the confidence value is determined by a comparison of the control action determined using the first method with the control action from the same setting determined using the second method. A second method at least partially controlling the mobile platform results in a good basis of comparison for the evaluation of the first method, since the settings of the surroundings of the mobile platform for both methods may be identical for determining the control actions.

According to one aspect of the present invention, it is provided that the confidence value is additionally or alternatively determined with the aid of a self-assessment of the first method.

According to one aspect of the present invention, it is provided that the confidence value is determined by a comparison of the control action determined using the first method and a control action of a vehicle driver of the at least semi-automated mobile platform from the same setting.

This advantageously results in the possibility of carrying out the comparison using a behavior of a vehicle driver of the mobile platform, even if a second method for at least partially controlling the mobile platform is not yet enabled for road traffic.

According to one aspect of the present invention, it is provided that the confidence value is determined with the aid of machine learning methods.

Examples of machine learning methods in this case are a (Bayesian) neural network, optionally in combination with fully connected neural networks, optionally using classical regularization and stabilization layers such as batch normalization and training drop-outs, using various activation functions such as sigmoid and ReLu, etc., classical approaches such as support vector machines, boosting, decision trees, Gaussian processes (in particular, with variance calculation for the prediction), as well as random forests.

According to one aspect of the present invention, it is provided that the confidence value is determined with the aid of a model-based method.

Such a model-based method may be generated using expert knowledge and a determination of the confidence value may be based on the model-based method being able to recognize whether the instantaneous input data, i.e., in particular, the representations of the surroundings, are in an extrapolation area of the method, i.e., for the model-based method, there are no sufficiently similar situations known from the training or from the manual specification phase, or is in an interpolation area, i.e., that a sufficient number of similar situations from the development phase for the model-based method is present.

A method is provided which, based on a control action determined using a first method, which has been determined using one of the above-described methods, provides a control signal for activating an at least semi-automated vehicle; and/or, based on the control action determined using a first method, provides a warning signal for warning a vehicle occupant.

The term “based on” is to be broadly understood with respect to the feature that a control signal is provided based on a control action determined using a first method. It is to be understood in such a way that the control action determined using the first method is used for every determination or calculation of a control signal, it not being precluded that still other input variables are also used for this determination of the control signal. This applies accordingly to the provision of a warning signal.

Highly-automated systems may, for example, initiate a transition into a safe state with such a control signal, in the case of an at least semi-automated vehicle, for example, by carrying out a slow stop on an emergency lane.

An evaluation device is provided, which is configured to carry out one of the above-described methods. With such an evaluation device, the method may be easily introduced into different mobile platforms.

According to one aspect of the present invention, a computer program is specified, which includes commands which, when the computer program is executed on a computer, prompt the computer to carry out one of the above-described methods. Such a computer program enables the use of the described methods in different systems.

A machine-readable memory medium is specified, on which the above-described computer program is stored. The above-described computer program is transportable with the aid of such a machine-readable memory medium.

### BRIEF DESCRIPTION OF THE DRAWINGS

Exemplary embodiments of the present invention are represented with reference to FIG. 1 and explained in greater detail below.

FIG. 1 shows an outline of a data flow for the method for evaluating a first method for controlling an at least semi-automated mobile platform.

### DETAILED DESCRIPTION OF EXAMPLE EMBODIMENTS

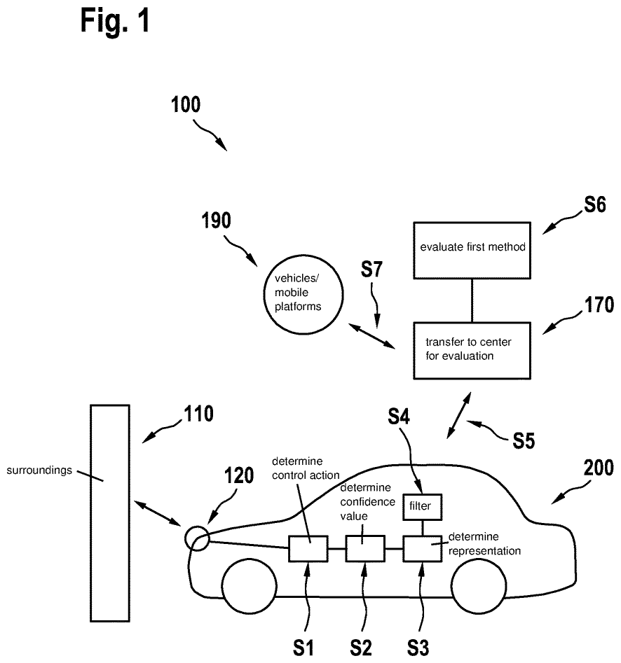

FIG. 1 schematically outlines a data flow of a method 100 for evaluating a first method for controlling an at least semi-automated mobile platform 200 in surroundings 110 of mobile platform 200. A representation of surroundings 110 may be generated from surroundings 110 of mobile platform 200 with the aid of sensors 120. The first method may be operated in a test mode for evaluating without having a direct influence on the control of mobile platform 200. Mobile platform 200 in this case may be at least partially controlled by a second method.

In a step S1, a control action is determined for a setting of the surroundings using the first method.

In a second step S2, a confidence value for the determination of the control action is determined using the first method.

The determination of the confidence value in this case may be determined by a comparison of the control action determined using the first method with the control action from the same setting determined using the second method, and additionally or alternatively by a comparison of the control action determined using the first method and a control action of a vehicle driver of the at least semi-automated mobile platform from the same setting, and additionally or alternatively with the aid of a machine learning system, and additionally or alternatively with the aid of a model-based method, or additionally or alternatively via a self-assessment of the first method.

In a step S3, a representation of the setting of surroundings 110 of mobile platform 200 is determined, if the determined confidence value is lower than a trust level, in order to evaluate the first method using this setting. In a step S4, it may be filtered whether the representation of the setting, in which the confidence value for the determination of the control action is lower than a trust level, is transferred to a center for evaluation 170. This means that only a part of the representations of the respective corresponding settings is transferred to the center for evaluation 170 of the first method. This part of the transferred representations of the respective setting may be dependent upon the representation of the respective setting and/or of the first method, in that only the representations of the settings are transferred that are necessary for evaluating the first method, in order to achieve a minimization of the volume of data to be transferred.

In a step S5, the respective representation of the setting that is to be transferred may be transferred to center 170.

This method may be carried out with a multitude of vehicles or mobile platforms 190 and may in each case be transferred to the center for evaluation 170 in a respective step S7. This transfer of the representations of the respective setting by the respective vehicle or mobile platform 200 for the corresponding control action may be transferred wirelessly by the multitude of vehicles or mobile platforms 190 to center 170.

In a step S6 of the method, the first method for controlling an at least semi-automated mobile platform may be evaluated using a plurality of representations of settings of a multitude of mobile platforms and the corresponding control actions. The first method in this case may be a method for the behavior planning of the at least semi-automated mobile platform.

1-15. (canceled)

16. A method for evaluating a first method for a control of an at least semi-automated mobile platform in surroundings of the mobile platform, comprising the following steps:
determining a respective control action using the first method for a respective setting of the surroundings;
determining a confidence value for the determination of the respective control action using the first method;
determining a representation of the respective setting of the surroundings of the at least one mobile platform, when the determined confidence value is lower than a trust level, to evaluate the first method using the setting.

17. The method as recited in claim 16, wherein the first method for the control of the at least semi-automated platform is a method for behavior planning of the at least semi-automated mobile platform.

18. The method as recited in claim 16, wherein the first method is evaluated using a multitude of at least semi-automated mobile platforms and/or the representation of the respective setting is transferred wirelessly by a portion of the multitude of the at least semi-automated mobile platforms to a center for evaluation of the first method.

19. The method as recited in claim 18, wherein only a part of the representation of the respective setting is transferred to the center for evaluation, and the part is dependent upon the representation of the respective setting and/or of the first method, to minimize a volume of data to be transferred.

20. The method as recited in claim 18, wherein the respective control action is transferred to the at least semi-automated mobile platform.

21. The method as recited in claim 16, wherein the first method is operated in a test mode in the at least semi-automated mobile platform.

22. The method as recited in claim 16, wherein the respective control action is determined using a second method, and the second method at least partially controls the at least semi-automated mobile platform for evaluating the first method.

23. The method as recited in claim 22, wherein the confidence value is determined by a comparison of the respective control action determined using the first method with a control action from the same setting determined using the second method.

24. The method as recited in claim 16, wherein the confidence value is determined by a comparison of the respective control action determined using the first method and a control action of a vehicle driver of the at least semi-automated mobile platform from the same setting.

25. The method as recited in claim 16, wherein the confidence value is determined using machine learning methods.

26. The method as recited in claim 16, wherein the confidence value is determined using a model-based method.

27. The method as recited in claim 16, wherein, based on the respective control action determined using a first method, a control signal is provided for activating the at least semi-automated vehicle; and/or, based on the respective control action determined using the first method, a warning signal is provided for warning a vehicle occupant.

28. An evaluation device configured to evaluate a first method for a control of an at least semi-automated mobile platform in surroundings of the mobile platform, the evaluation device configured to:
determine a respective control action using the first method for a respective setting of the surroundings;
determine a confidence value for the determination of the respective control action using the first method;
determine a representation of the respective setting of the surroundings of the at least one mobile platform, when the determined confidence value is lower than a trust level, to evaluate the first method using the setting.

29. A non-transitory machine-readable memory medium on which is stored a computer program for evaluating a first method for a control of an at least semi-automated mobile platform in surroundings of the mobile platform, the computer program, when executed by a computer, causing the computer to perform the following steps:
determining a respective control action using the first method for a respective setting of the surroundings;
determining a confidence value for the determination of the respective control action using the first method;
determining a representation of the respective setting of the surroundings of the at least one mobile platform, when the determined confidence value is lower than a trust level, to evaluate the first method using the setting.
